(19) United States
(12) Patent Application Publication
(10) Pub. No.: US 2006/0254315 A1
(43) Pub. Date: Nov. 16, 2006

(54) Process for the production of inverse opal-like structures

(76) Inventors: Holger Winkler, Darmstadt (DE); Goetz Peter Hellmann, Mainz (DE); Tilmann Eberhard Ruhl, Griesheim (DE); Peter Spahn, Hanau (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/529,793

(22) PCT Filed: Sep. 2, 2003
(86) PCT No.: PCT/EP03/09717

§ 371 Date: Mar. 30, 2005

(30) Foreign Application Priority Data
Sep. 30, 2002 (DE) 10245848.0

(51) Int. Cl. C03B 19/10; C03B 23/00

(52) U.S. Cl. 65/21.4

(57) ABSTRACT

The invention relates to the use of core/shell particles whose shell forms a matrix and whose core is essentially solid and has an essentially monodisperse size distribution as template for the production of inverse opal structures, and to a process for the production of inverse opal-like structures using core/shell particles of this type.

The invention relates to the use of core/shell particles as template for the production of inverse opal-like structures, and to a process for the production of inverse opal-like structures.

The term three-dimensional photonic structures is generally taken to mean systems which have a regular, three-dimensional modulation of the dielectric constants (and thus also of the refractive index). If the periodic modulation length corresponds approximately to the wavelength of (visible) light, the structure interacts with the light in the manner of a three-dimensional diffraction grating, which is evident from angle-dependent colour phenomena. An example of this is the naturally occurring precious stone opal, which consists of silicon dioxide spheres in spherical closest packing with air- or water-filled cavities in between. The inverse structure thereto is notionally formed by regular spherical cavities being arranged in closest packing in a solid material. An advantage of inverse structures of this type over the normal structures is the formation of photonic band gaps with much lower dielectric constant contrasts still (K. Busch et al. Phys. Rev. Letters E, 198, 50, 3896). TiO₂ in particular is a suitable material for the formation of a photonic structure since it has a high refractive index.

Three-dimensional inverse structures can be produced by template synthesis:
Monodisperse spheres are arranged in spherical closest packing as structure-forming templates.
The cavities between the spheres are filled with a gaseous or liquid precursor or a solution of a precursor utilising capillary effects.
The precursor is converted (thermally) into the desired material.
The templates are removed, leaving behind the inverse structure.

Many such processes are disclosed in the literature. For example, SiO₂ spheres can be arranged in closest packing and the cavities filled with tetraethyl orthotitanate-containing solutions. After a number of conditioning steps, the spheres are removed using HF in an etching process, leaving behind the inverse structure of titanium dioxide (V. Colvin et al. Adv. Mater. 2001, 13, 180).

De La Rue et al. (De La Rue et al. Synth. Metals, 2001, 116, 469) describe the production of inverse opals consisting of TiO₂ by the following method: a dispersion of 400 nm polystyrene spheres is dried on a filter paper under an IR lamp. The filter cake is washed by sucking through ethanol, transferred into a glove box and infiltrated with tetraethyl orthotitanate by means of a water-jet pump. The filter paper is carefully removed from the latex/ethoxide composite, and the composite is transferred into a tubular furnace. Calcination in a stream of air is carried out in the tubular furnace at 575° C. for 8 h, causing the formation of titanium dioxide from the ethoxide and burning out the latex particles. An inverse opal structure of TiO₂ remains behind.

Martinelli et al. (M. Martinelli et al. Optical Mater. 2001, 17, 11) describe the production of inverse TiO₂ opals using 780 nm and 3190 nm polystyrene spheres. A regular arrangement in spherical closest packing is achieved by centrifuging the aqueous sphere dispersion at 700-1000 rpm for 24-48 hours followed by decantation and drying in air. The regularly arranged spheres are moistened with ethanol on a filter in a Buchner funnel and then provided dropwise with an ethanolic solution of tetraethyl orthotitanate. After the titanate solution has percolated in, the sample is dried in a vacuum desiccator for 4-12 hours. This filling procedure is repeated 4 to 5 times. The polystyrene spheres are subsequently burnt out at 600° C.-800° C. for 8-10 hours.

Stein et al. (A. Stein et al. Science, 1998, 281, 538) describe the synthesis of inverse TiO₂ opals starting from polystyrene spheres having a diameter of 470 nm as template. These are produced in a 28-hour process, subjected to centrifugation and air-dried. The latex templates are then applied to a filter paper. Ethanol is sucked into the latex template via a Büchner funnel connected to a vacuum pump. Tetraethyl orthotitanate is then added dropwise with suction. After drying in a vacuum desiccator for 24 h, the latices are burnt out at 575° C. for 12 h in a stream of air.

Vos et al. (W. L. Vos et al. Science, 1998, 281, 802) produce inverse TiO₂ opals using polystyrene spheres having diameters of 180-1460 nm as template. In order to establish spherical closest packing of the spheres, a sedimentation technique is used supported by centrifugation over a period of up to 48 h. After slow evacuation in order to dry the template structure, an ethanolic solution of tetra-n-propoxy orthotitanate is added to the latter in a glove box. After about 1 h, the infiltrated material is brought into the air in order to allow the precursor to react to give TiO₂. This procedure is repeated eight times in order to ensure complete filling with TiO₂. The material is then calcined at 450° C.

The production of photonic structures from inverse opals is very complex and time-consuming by the processes described in the literature:
lengthy/complex production of the template or the arrangement of the spheres forming the template-forming structure in spherical closest packing
filling of the cavities of the template structure with precursors, which is lengthy/complex since it frequently has to be carried out a number of times
lengthy/complex procedure for removal of the templates
only limited or no possibility of the production of relatively large photonic structures having an inverse opal structure and scale-up of the laboratory synthesis into industrial production.

The disadvantages make the production of the desired photonic materials having an inverse opal structure more difficult. There is consequently a demand for a production process which is simple to implement and can also be scaled up to an industrial scale.

Core/shell particles whose shell forms a matrix and whose core is essentially solid and has an essentially monodisperse size distribution are described in the earlier German patent application DE 10145450.3

Surprisingly, it has been found that core/shell particles of this type are eminently suitable as template for the production of inverse opal structures.

The present invention therefore relates firstly to the use of the core/shell particles whose shell forms a matrix and whose core is essentially solid and has an essentially monodisperse size distribution as template for the production of inverse opal structures.

The present invention furthermore relates to a process for the production of inverse opal structures, characterised in that
a) a dispersion of core/shell particles whose shell forms a matrix and whose core is essentially solid is dried,
b) optionally one or more precursors of suitable wall materials are added, and
c) the cores are subsequently removed.

The use according to the invention of core/shell particles results, in particular, in the following advantages:
on drying of dispersions of core/shell particles, cracking in the template (=arrangement of the spheres)) during drying can be reduced or even prevented entirely,
large-area regions of high order can be obtained in the template,
stresses which arise during the drying process can be compensated for by the elastic nature of the shell,
if polymers form the shell, these can intertwine with one another and thus mechanically stabilise the regular sphere arrangement in the template,
if the shell is strongly bonded to the core—preferably by grafting—via an interlayer, the templates can be processed via melt processes.

It is therefore particularly preferred in accordance with the invention for the shell in the core/shell particles to be bonded to the core via an interlayer.

In order to achieve the optical or photonic effect according to the invention, it is desirable for the core/shell particles to have a mean particle diameter in the range from about 5 nm to about 2000 nm. It may be particularly preferred here for the core/shell particles to have a mean particle diameter in the range from about 5 to 20 nm, preferably 5 to 10 nm. In this case, the cores may be known as “quantum dots”; they exhibit the corresponding effects known from the literature. In order to achieve colour effects in the region of visible light, it is particularly advantageous for the core/shell particles to have a mean particle diameter in the range from about 50-500 nm. Particular preference is given to the use of particles in the range 100-500 nm, since in particles in this size range (depending on the refractive-index contrast which can be achieved in the photonic structure), the reflections of various wavelengths of visible light differ significantly from one another, and thus the opalescence which is particularly important for optical effects in the visible region occurs to a particularly pronounced extent in a very wide variety of colours. However, it is also preferred in a variant of the present invention to employ multiples of this preferred particle size, which then result in reflections corresponding to the higher orders and thus in a broad colour play.

In a preferred embodiment of the invention, the interlayer is a layer of crosslinked or at least partially crosslinked polymers. The crosslinking of the interlayer here can take place via free radicals, for example induced by UV irradiation, or preferably via di- or oligofunctional monomers. Preferred interlayers in this embodiment comprise 0.01 to 100% by weight, particularly preferably 0.25 to 10% by weight, of di- or oligofunctional monomers. Preferred di- or oligofunctional monomers are, in particular, isoprene and allyl methacrylate (ALMA). Such an interlayer of crosslinked or at least partially crosslinked polymers preferably has a thickness in the range from 10 to 20 nm. If the interlayer comes out thicker, the refractive index of the layer is selected so that it corresponds either to the refractive index of the core or to the refractive index of the shell.

If copolymers which, as described above, contain a crosslinkable monomer are employed as interlayer, the person skilled in the art will have absolutely no problems in suitably selecting corresponding copolymerisable monomers. For example, corresponding copolymerisable monomers can be selected from a so-called Q-e-scheme (cf. textbooks on macro-molecular chemistry). Thus, monomers such as methyl methacrylate and methyl acrylate can preferably be polymerised with ALMA.

In another, likewise preferred embodiment of the present invention, shell polymers are grafted directly onto the core via a corresponding functionalisation of the core. The surface functionalisation of the core here forms the interlayer according to the invention. The type of surface functionalisation here depends principally on the material of the core. Silicon dioxide surfaces can, for example, be suitably modified with silanes carrying correspondingly reactive end groups, such as epoxy functions or free double bonds. In the case of polymeric cores, the surface modification can be carried out, for example, using a styrene which is functionalised on the aromatic ring, such as bromostyrene: This functionalisation then allows growing-on of the shell polymers to be achieved. In particular, the interlayer can also effect adhesion of the shell to the core via ionic interactions or complex bonds.

In a preferred embodiment, the shell of these core/shell particles consists of essentially uncrosslinked organic polymers, which are preferably grafted onto the core via an at least partially crosslinked interlayer.

The shell here can consist either of thermoplastic or elastomeric polymers. The core can consist of a very wide variety of materials. The only essential factor for the purposes of the present invention is that the core and, in a variant of the invention, preferably also the interlayer and shell can be removed under conditions under which the wall material is stable. The choice of suitable core/shell/interlayer-wall material combinations presents the person skilled in the art with absolutely no difficulties.

It is furthermore particularly preferred in a variant of the invention for the core to consist of an organic polymer, which is preferably crosslinked.

In another variant of the invention which is explained in greater detail below, the cores consist of an inorganic material, preferably a metal or semimetal or a metal chalcogenide or metal pnictide. For the purposes of the present invention, chalcogenides are taken to mean compounds in which an element from group 16 of the Periodic Table of the Elements is the electronegative bonding partner; pnictides are taken to mean those in which an element from group 15 of the Periodic Table of the Elements is the electronegative bonding partner. Preferred cores consist of metal chalcogenides, preferably metal oxides, or metal pnictides, preferably nitrides or phosphides. Metal in the sense of these terms are all elements which can occur as electropositive partner compared with the counterions, such as the classical metals of the sub-groups, or the main-group metals from the first and second main group, but also all elements from the third main group, as well as silicon, germanium, tin, lead, phosphorus, arsenic, antimony and bismuth. The preferred metal chalcogenides and metal pnictides include; in particular, silicon dioxide, aluminium oxide, gallium nitride, boron nitride, aluminium nitride, silicon nitride and phosphorus nitride. The starting material employed for the production of the core/shell particles to be employed in accordance with the invention in a variant of the present invention are preferably monodisperse cores of silicon dioxide, which can be obtained, for example, by the process described in U.S. Pat. No. 4,911,903. The cores here are produced by hydrolytic polycondensation of tetraalkoxysilanes in an aqueous-ammoniacal medium, where firstly a sol of primary particles is produced, and the resultant SiO₂ particles are subsequently converted into the desired particle size by continuous, controlled metered addition of tetraalkoxysilane. This process enables the production of monodisperse SiO₂ cores having mean particle diameters of between 0.05 and 10 μm with a standard deviation of 5%. The starting material employed can also be monodisperse cores of non-absorbent metal oxides, such as TiO₂, ZrO₂, ZnO₂, SnO₂ or Al₂O₃, or metal-oxide mixtures. Their production is described, for example, in EP 0 644 914. Furthermore, the process of EP 0 216 278 for the production of monodisperse SiO₂ cores can readily be applied to other oxides with the same result. Tetraethoxysilane, tetrabutoxytitanium, tetrapropoxyzirconium or mixtures thereof are added in one portion, with vigorous mixing, to a mixture of alcohol, water and ammonia, whose temperature is set precisely to 30 to 40° C. using a thermostat, and the resultant mixture is stirred vigorously for a further 20 seconds, giving a suspension of monodisperse cores in the nanometre region. After a post-reaction time of from 1 to 2 hours, the cores are separated off in a conventional manner, for example by centrifugation, washed and dried.

The wall of the inverse opal structures obtainable in accordance with the invention is, in an embodiment of the present invention, preferably formed from an inorganic material, preferably a metal chalcogenide or metal pnictide. In the present description, this material is also referred to as wall material. For the purposes of the present invention, chalcogenides are taken to mean compounds in which an element from group 16 of the Periodic Table is the electronegative bonding partner; pnictides are taken to mean those in which an element from group 15 of the Periodic Table is the electronegative bonding partner. Preferred wall materials are metal chalcogenides, preferably metal oxides, or metal pnictides, preferably nitrides or phosphides. Metal in the sense of these terms are all elements which can occur as electropositive partner compared with the counterions, such as the classical metals of the sub-groups, such as, in particular, titanium and zirconium, or the main-group metals from the first and second main groups, but also all elements from the third main group, as well as silicon, germanium, tin, lead, phosphorus, arsenic, antimony and bismuth. The preferred metal chalcogenides include, in particular, silicon dioxide, aluminium oxide and particularly preferably titanium dioxide.

The starting material (precursor) employed for the production of the inverse opals in accordance with this variant of the invention can in principle be all conceivable precursors which are liquid, sinterable or soluble and which can be converted into stable solids by a sol-gel-analogous conversion. Sinterable precursors here are taken to mean ceramic or pre-ceramic particles, preferably nanoparticles, which can be converted into a moulding—the inverse opal—by—as usual in ceramics—sintering, if desired with elimination of readily volatile by-products. The relevant ceramic literature (for example H. P. Baldus, M. Jansen, Angew. Chem. 1997, 109, 338-354) discloses precursors of this type to the person skilled in the art. Gaseous precursors, which can be infiltrated into the template structure by a CVD-analogous method known per se, can furthermore also be employed. In a preferred variant of the present invention, use is made of solutions of one or more esters of a corresponding inorganic acid with a lower alcohol, such as, for example, tetraethoxysilane, tetrabutoxytitanium, tetrapropoxyzirconium or mixtures thereof.

In a second, likewise preferred variant of the invention, the wall of the inverse opal is formed from the polymers of the shell of the core/shell particles, which are preferably crosslinked with one another. In this variant of the invention, the addition of precursors in step b) can be omitted or replaced by the addition of crosslinking agents. In this variant of the invention, it may be preferred for the cores to consist of an inorganic material described above.

In the process according to the invention for the production of an inverse opal structure, a dispersion of the core/shell particles described above is dried in a first step. The drying here is carried out under conditions which enable the formation of a “positive” opal structure, which then serves as template in the remainder of the process. This can be carried out, for example, by careful removal of the dispersion medium, by slow sedimentation or by the application of a mechanical force to a pre-dried mass of core/shell particles.

For the purposes of the present invention, the action of mechanical force can be the action of a force which takes place in the conventional processing steps of polymers. In preferred variants of the present invention, the action of mechanical force takes place either:
through uniaxial pressing or
action of force during an injection-moulding operation or
during a transfer moulding operation,
during (co)extrusion or
during a calendering operation or
during a blowing operation.

If the action of force takes place through uniaxial pressing, the mouldings according to the invention are preferably films. Films according to the invention can preferably also be produced by calendering, film blowing or flat-film extrusion. The various ways of processing polymers under the action of mechanical forces are well known to the person skilled in the art and are revealed, for example, by the standard textbook Adolf Franck, “Kunststoff-Kompendium” [Plastics Compendium]; Vogel-Verlag; 1996. The processing of core/shell particles through the action of mechanical force, as is preferred here, is furthermore described in detail in international patent application WO 2003025035.

A precursor of suitable wall materials is preferably subsequently added to the template, as described above. In a preferred variant of the process according to the invention for the production of inverse opal structures, the precursor is therefore a solution of an ester of an inorganic ortho-acid with a lower alcohol, preferably tetraethoxysilane, tetrabutoxytitanium, tetrapropoxyzirconium or mixtures thereof. Suitable solvents for the precursors are, in particular, lower alcohols, such as methanol, ethanol, n-propanol, isopropanol or n-butanol.

As has been shown, it is advantageous to allow the precursors or alternatively the crosslinking agent to act on the template structure of core/shell particles for some time under a protective-gas cushion before condensation of the wall material in order to effect uniform penetration into the cavities. For the same reason, it is advantageous for the precursors or the crosslinking agent to be added to the template structure under reduced pressure, preferably in a static vacuum of p<1 mbar.

The formation of the wall material from the precursors is carried out either by addition of water and/or by heating the reaction batch. In the case of alkoxide precursors, heating in air is generally sufficient for this purpose. Under certain circumstances, it may be advantageous to wash the impregnated template briefly with a small amount of a solvent in order to wash off precursor adsorbed onto the surface. With this step, the formation of a thick layer of wall material, which can act as diffuser, on the surface of the template can be prevented. For the same reason, it may be advantageous also to dry the impregnated structure under mild conditions before the calcination.

The removal of the cores in step c) can be carried out by various methods. For example, the cores can be removed by dissolution or by burning out.

In a preferred variant of the process according to the invention, step c) comprises calcination of the wall material, preferably at temperatures above 200° C., particularly preferably above 400° C. If, in the variant of the invention described above, a precursor is employed for the formation of the wall, it is particularly preferred for all the core/shell particles to be removed together with the cores.

If the cores consist of suitable inorganic materials, these can be removed by etching. This procedure is particularly preferred if the shell polymers are intended to form the wall of the inverse opal structure. Silicon dioxide cores, for example, can preferably be removed using HF, in particular dilute HF solution. It may in turn be preferred in this procedure for crosslinking of the shell to take place before removal of the cores, as described above.

If the cavities of the inverse opal structure are to be re-impregnated with liquid or gaseous materials, however, it may also be preferred for the shell to be crosslinked only to a very small extent, or not at all. The impregnation here can consist, for example, in inclusion of liquid crystals, as described, for example, in Ozaki et al., Adv. Mater. 2002, 14, 514 and Sato et al., J. Am. Chem. Soc. 2002, 124, 10950.

Those obtainable in accordance with the invention are suitable firstly for the above-described use as photonic material, preferably with the impregnation mentioned, but secondly also for the production of porous surfaces, membranes, separators, filters and porous supports. These materials can also be used, for example, as fluidised beds in fluidised-bed reactors.

Owing to the considerations mentioned here, it is advantageous for the shell of the core/shell particles according to the invention to comprise one or more polymers and/or copolymers or polymer precursors and, if desired, auxiliaries and additives, where the composition of the shell may be selected in such a way that it is essentially dimensionally stable and tack-free in a non-swelling environment at room temperature.

With the use of polymer substances as shell material and, if desired, core material, the person skilled in the art gains the freedom to determine their relevant properties, such as, for example, their composition, the particle size, the mechanical data, the glass transition temperature, the melting point and the core/shell weight ratio and thus also the applicational properties of the core/shell particles, which ultimately also affect the properties of the inverse opal structure produced therefrom.

Polymers and/or copolymers which may be present in the core material or of which it consists are high-molecular-weight compounds which conform to the specification given above for the core material. Both polymers and copolymers of polymerisable unsaturated monomers and polycondensates and copolycondensates of monomers containing at least two reactive groups, such as, for example, high-molecular-weight aliphatic, aliphatic/aromatic or fully aromatic polyesters, polyamides, polycarbonates, polyureas and polyurethanes, but also amino and phenolic resins, such as, for example, melamine-formaldehyde, urea-formaldehyde and phenol-formaldehyde condensates, are suitable.

For the production of epoxy resins, which are likewise suitable as core material, epoxide prepolymers, which are obtained, for example, by reaction of bisphenol A or other bisphenols, resorcinol, hydroquinone, hexanediol or other aromatic or aliphatic diols or polyols, or phenol-formaldehyde condensates, or mixtures thereof with one another, with epichlorohydrin or other di- or polyepoxides, are usually mixed with further condensation-capable compounds directly or in solution and allowed to cure.

The polymers of the core material are advantageously, in a preferred variant of the invention, crosslinked (co)polymers, since these usually only exhibit their glass transition at high temperatures. These crosslinked polymers may either already have been crosslinked during the polymerisation or polycondensation or copolymerisation or copolycondensation or they may have been post-crosslinked in a separate process step after the actual (co)polymerisation or (co)polycondensation.

A detailed description of the chemical composition of suitable polymers follows below.

In principle, polymers of the classes already mentioned above, if they are selected or constructed in such a way that they conform to the specification given above for the shell polymers, are suitable for the shell material and for the core material.

Polymers which meet the specifications for a shell material are likewise present in the groups of polymers and copolymers of polymerisable unsaturated monomers and polycondensates and copolycondensates of monomers containing at least two reactive groups, such as, for example, high-molecular-weight aliphatic, aliphatic/aromatic or fully aromatic polyesters and polyamides.

Taking into account the above conditions for the properties of the shell polymers (=matrix polymers), selected units from all groups of organic film formers are in principle suitable for their preparation.

Some further examples are intended to illustrate the broad range of polymers which are suitable for the production of the shells.

If the shell is intended to have a comparatively low refractive index, polymers such as polyethylene, polypropylene, polyethylene oxide, polyacrylates, polymethacrylates, polybutadiene, polymethyl methacrylate, polytetrafluoroethylene, polyoxymethylene, polyesters, polyamides, polyepoxides, polyurethane, rubber, polyacrylonitrile and polyisoprene, for example, are suitable.

If the shell is intended to have a comparatively high refractive index, polymers having a preferably aromatic basic structure, such as polystyrene, polystyrene copolymers, such as, for example, SAN, aromatic-aliphatic polyesters and polyamides, aromatic polysulfones and polyketones, polyvinyl chloride, polyvinylidene chloride and, on suitable selection of a high-refractive-index core material, also polyacrylonitrile or polyurethane, for example, are suitable for the shell.

In an embodiment of core/shell particles which is particularly preferred in accordance with the invention, the core consists of crosslinked polystyrene and the shell of a polyacrylate, preferably polyethyl acrylate, polybutyl acrylate, polymethyl methacrylate and/or a copolymer thereof.

With respect to the ability of the core/shell particles to be converted into inverse opal structures, it is advantageous, if the wall material results from a precursor solution, for the core shell weight ratio to be in the range from 20:1 to 1.4:1, preferably in the range from 6:1 to 2:1 and particularly preferably in the range 5:1 to 3.5:1. If the wall of the inverse opal structure is formed from shell polymers, it is preferred for the core shell weight ratio to be in the range from 5:1 to 1:10, in particular in the range from 2:1 to 1:5 and particularly preferably in the region below 1:1.

The core/shell particles which can be used in accordance with the invention can be produced by various processes.

A preferred way of obtaining the particles is a process for the production of core/shell particles by a) surface treatment of monodisperse cores, and b) application of the shell of organic polymers to the treated cores. In a process variant, the monodisperse cores are obtained in a step a) by emulsion polymerisation.

In a preferred process variant, a crosslinked polymeric interlayer, which preferably contains reactive centres to which the shell can be covalently bonded, is applied to the cores in step a), preferably by emulsion polymerisation or by ATR polymerisation. ATR polymerisation here stands for atom transfer radical polymerisation, as described, for example, in K. Matyjaszewski, Practical Atom Transfer Radical Polymerisation, Polym. Mater. Sci. Eng. 2001, 84. The encapsulation of inorganic materials by means of ATRP is described, for example, in T. Werne, T. E. Patten, Atom Transfer Radical Polymerisation from Nanoparticles: A Tool for the Preparation of Well-Defined Hybrid Nanostructures and for Understanding the Chemistry of Controlled/“Living” Radical Polymerisation from Surfaces, J. Am. Chem. Soc. 2001, 123, 7497-7505 and WO 00/11043. The performance both of this method and of emulsion polymerisations is familiar to the person skilled in the art of polymer preparation and is described, for example, in the above-mentioned literature references.

The liquid reaction medium in which the polymerisations or copolymerisations can be carried out consists of the solvents, dispersion media or diluents usually employed in polymerisations, in particular in emulsion polymerisation processes. The choice here is made in such a way that the emulsifiers employed for homogenisation of the core particles and shell precursors are able to develop adequate efficacy. Suitable liquid reaction media for carrying out the process according to the invention are aqueous media, in particular water.

Suitable for initiation of the polymerisation are, for example, polymerisation initiators which decompose either thermally or photochemically, form free radicals and thus initiate the polymerisation. Preferred thermally activatable polymerisation initiators here are those which decompose at between 20 and 180° C., in particular at between 20 and 80° C. Particularly preferred polymerisation initiators are peroxides, such as dibenzoyl peroxide di-tert-butyl peroxide, peresters, percarbonates, perketals, hydroperoxides, but also inorganic peroxides, such as H₂O₂, salts of peroxosulfuric acid and peroxodisulfuric acid, azo compounds, alkylboron compounds, and hydrocarbons which decompose homolytically. The initiators and/or photoinitiators, which, depending on the requirements of the polymerised material, are employed in amounts of between 0.01 and 15% by weight, based on the polymerisable components, can be used individually or, in order to utilise advantageous synergistic effects, in combination with one another. In addition, use is made of redox systems, such as, for example, salts of peroxodisulfuric acid and peroxosulfuric acid in combination with low-valency sulfur compounds, particularly ammonium peroxodisulfate in combination with sodium dithionite.

Corresponding processes have also been described for the production of polycondensation products. Thus, it is possible for the starting materials for the production of polycondensation products to be dispersed in inert liquids and condensed, preferably with removal of low-molecular-weight reaction products, such as water or—for example on use of di(lower alkyl) dicarboxylates for the preparation of polyesters or polyamides—lower alkanols.

Polyaddition products are obtained analogously by reaction by compounds which contain at least two, preferably three, reactive groups, such as, for example, epoxide, cyanate, isocyanate or isothiocyanate groups, with compounds carrying complementary reactive groups. Thus, isocyanates react, for example, with alcohols to give urethanes, with amines to give urea derivatives, while epoxides react with these complementary groups to give hydroxyethers and hydroxyamines respectively. Like the polycondensations, polyaddition reactions can also advantageously be carried out in an inert solvent or dispersion medium.

It is also possible for aromatic, aliphatic or mixed aromaticaliphatic polymers, for example polyesters, polyurethanes, polyamides, polyureas, polyepoxides or also solution polymers, to be dispersed or emulsified (secondary dispersion) in a dispersion medium, such as, for example, in water, alcohols, tetrahydrofuran, hydrocarbons, and to be post-condensed, crosslinked and cured in this fine distribution.

The stable dispersions required for these polymerisation polycondensation or polyaddition processes are generally prepared using dispersion auxiliaries.

The dispersion auxiliaries used are preferably water-soluble, high-molecular-weight organic compounds containing polar groups, such as polyvinylpyrrolidone, copolymers of vinyl propionate or acetate and vinylpyrrolidone, partially saponified copolymers of an acrylate and acrylonitrile, polyvinyl alcohols having different residual acetate contents, cellulose ethers, gelatine, block copolymers, modified starch, low-molecular-weight polymers containing carboxyl and/or sulfonyl groups, or mixtures of these substances.

Particularly preferred protective colloids are polyvinyl alcohols having a residual acetate content of less than 35 mol %, in particular from 5 to 39 mol %, and/or vinylpyrrolidone-vinyl propionate copolymers having a vinyl ester content of less than 35% by weight, in particular from 5 to 30% by weight.

It is possible to use nonionic or ionic emulsifiers, if desired also as a mixture. Preferred emulsifiers are optionally ethoxylated or propoxylated, relatively long-chain alkanols or alkylphenols having different degrees of ethoxylation or propoxylation (for example adducts with from 0 to 50 mol of alkylene oxide) or neutralised, sulfated, sulfonated or phosphated derivatives thereof. Neutralised dialkylsulfosuccinic acid esters or alkyldiphenyl oxide disulfonates are also particularly suitable.

Particularly advantageous are combinations of these emulsifiers with the above-mentioned protective colloids, since particularly finely divided dispersions are obtained therewith.

Special processes for the production of monodisperse polymer particles have also already been described in the literature (for example R. C. Backus, R. C. Williams, J. Appl, Physics 19, p. 1186, (1948) and can advantageously be employed, in particular, for the production of the cores. It need merely be ensured here that the above-mentioned particle sizes are observed. A further aim is the greatest possible uniformity of the polymers. The particle size in particular can be set via the choice of suitable emulsifiers and/or protective colloids or corresponding amounts of these compounds.

Through the setting of the reaction conditions, such as temperature, pressure, reaction duration and use of suitable catalyst systems, which influence the degree of polymerisation in a known manner, and the choice of the monomers employed for their production—in terms of type and proportion—the desired property combinations of the requisite polymers can be set specifically. The particle size here can be set, for example, through the choice and amount of the initiators and other parameters, such as the reaction temperature. The corresponding setting of these parameters does not present any difficulties at all to the person skilled in the art in the area of polymerisation.

Monomers which result in polymers having a high refractive index are generally those which contain aromatic moieties or those which contain hetero atoms having a high atomic number, such as, for example, halogen atoms, in particular bromine or iodine atoms, sulfur or metal ions, i.e. atoms or atomic groups which increase the polarisability of the polymers.

Polymers having a low refractive index are accordingly obtained from monomers or monomer mixtures which do not contain the said moieties and/or atoms of high atomic number or only do so in a small proportion.

A review of the refractive indices of various common homopolymers is given, for example, in Ullmanns Encyklopädie der technischen Chemie [Ullmann's Encyclopaedia of Industrial Chemistry], 5th Edition, Volume A21, page 169. Examples of monomers which can be polymerised by means of free radicals and result in polymers having a high refractive index are:

Group a): styrene, styrenes which are alkyl-substituted on the phenyl ring, α-methylstyrene, mono- and dichlorostyrene, vinyinaphthalene, isopropenyinaphthalene, isopropenylbiphenyl, vinylpyridine, isopropenylpyridine, vinylcarbazole, vinylanthracene, N-benzylmethacrylamide, p-hydroxymethacrylanilide.

Group b): acrylates containing aromatic side chains, such as, for example, phenyl (meth)acrylate (=abbreviated notation for the two compounds phenyl acrylate and phenyl methacrylate), phenyl vinyl ether, benzyl (meth)acrylate, benzyl vinyl ether, and compounds of the formulae:

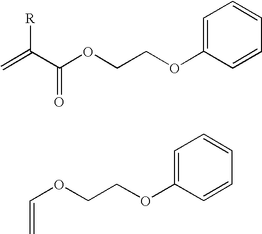

In order to improve clarity and simplify the notation of carbon chains in the formulae above and below, only the bonds between the carbon atoms are shown. This notation corresponds to the depiction of aromatic cyclic compounds, where, for example, benzene is depicted by a hexagon with alternating single and double bonds.

Also suitable are compounds containing sulfur bridges instead of oxygen bridges, such as, for example:

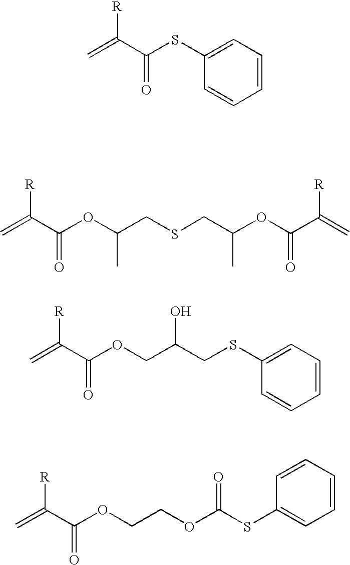

In the above formulae, R stands for hydrogen or methyl. The phenyl rings in these monomers may carry further substituents. Such substituents are suitable for modifying the properties of the polymers produced from these monomers within certain limits. They can therefore be used in a targeted manner to optimise, in particular, the applicationally relevant properties of the mouldings according to the invention.

Suitable substituents are, in particular, halogen, NO₂, alkyl groups having one to twenty C atoms, preferably methyl, alkoxides having one to twenty C atoms, carboxyalkyl groups having one to twenty C atoms, carbonylalkyl groups having one to twenty C atoms or —OCOO-alkyl groups having one to twenty C atoms. The alkyl chains in these radicals may themselves optionally be substituted or interrupted by divalent hetero atoms or groups, such as, for example, —O—, —S—, —NH—, —COO—, —OCO— or —OCOO—, in non-adjacent positions.

Group c): monomers containing hetero atoms, such as, for example, vinyl chloride, acrylonitrile, methacrylonitrile, acrylic acid, methacrylic acid, acrylamide and methacrylamide, or organometallic compound, such as, for example,

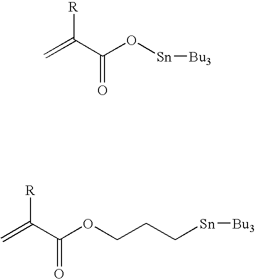

Group d): an increase in the refractive index of polymers is also achieved by copolymerisation of carboxyl-containing monomers and conversion of the resultant “acidic” polymers into the corresponding salts with metals of relatively high atomic weight, such as, for example, preferably with K, Ca, Sr, Ba, Zn, Pb, Fe, Ni, Co, Cr, Cu, Mn, Sn or Cd.

The above-mentioned monomers, which make a considerable contribution towards the refractive index of the polymers prepared therefrom, can be homopolymerised or copolymerised with one another. They can also be copolymerised with a certain proportion of monomers which make a lesser contribution towards the refractive index. Such copolymerisable monomers having a lower refractive index contribution are, for example, acrylates, methacrylates, vinyl ethers or vinyl esters containing purely aliphatic radicals.

In addition, crosslinking agents which can be employed for the production of crosslinked polymer cores from polymers produced by means of free radicals are also all bi- or polyfunctional compounds which are copolymerisable with the above-mentioned monomers or which can subsequently react with the polymers with crosslinking.

Examples of suitable crosslinking agents will be presented below, divided into groups for systematisation:

Group 1: bisacrylates, bismethacrylates and bisvinyl ethers of aromatic or aliphatic di- or polyhydroxyl compounds, in particular of butanediol (butanediol di(meth)acrylate, butanediol bisvinyl ether), hexanediol (hexanediol di(meth)acrylate, hexanediol bisvinyl ether), pentaerythritol, hydroquinone, bishydroxyphenylmethane, bishydroxyphenyl ether, bishydroxymethylbenzene, bisphenol A or with ethylene oxide spacers, propylene oxide spacers or mixed ethylene oxide/propylene oxide spacers.

Further crosslinking agents from this group are, for example, di- or polyvinyl compounds, such as divinylbenzene, or methylenebisacrylamide, triallyl cyanurate, divinylethyleneurea, trimethylolpropane tri(meth)acrylate, trimethylolpropane trivinyl ether, pentaerythritol tetra(meth)acrylate, pentaerythritol tetravinyl ether, and crosslinking agents having two or more different reactive ends, such as, for example, (meth)allyl (meth)acrylates of the formulae: 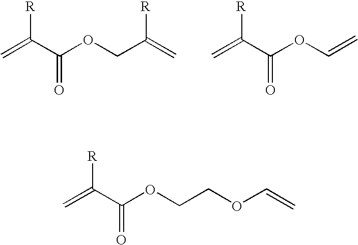
(in which R denotes hydrogen or methyl).

Group 2: reactive crosslinking agents which act in a crosslinking manner, but in most cases in a post-crosslinking manner, for example during warming or drying, and which are copolymerised into the core or shell polymers as copolymers.

Examples thereof are: N-methylol(meth)acrylamide, acrylamidoglycolic acid, and ethers and/or esters thereof with C₁ to C₆-alcohols, diacetone-acrylamide (DAAM), glycidyl methacrylate (GMA), methacryloyloxypropyl-trimethoxysilane (MEMO), vinyltrimethoxysilane, m-isopropenylbenzyl isocyanate (TMI).

Group 3: carboxyl groups which have been incorporated into the polymer by copolymerisation of unsaturated carboxylic acids are crosslinked in a bridge-like manner via polyvalent metal ions. The unsaturated carboxylic acids employed for this purpose are preferably acrylic acid, methacrylic acid, maleic anhydride, itaconic acid and fumaric acid. Suitable metal ions are Mg, Ca; Sr, Ba, Zn, Pb, Fe, Ni, Co, Cr, Cu, Mn, Sn, Cd. Particular preference is given to Ca, Mg and Zn, Ti and Zr. In addition, monovalent metal ions, such as, for example, Na or K, are also suitable.

Group 4: post-crosslinked additives, which are taken to mean bis- or polyfunctionalised additives which react irreversibly with the polymer (by addition or preferably condensation reactions) with formation of a network. Examples thereof are compounds which contain at least two of the following reactive groups per molecule: epoxide, aziridine, isocyanate acid chloride, carbodiimide or carbonyl groups, furthermore, for example, 3,4-dihydroxyimidazolinone and derivatives thereof (®Fixapret@ products from BASF).

As already explained above, post-crosslinking agents containing reactive groups, such as, for example, epoxide and isocyanate groups, require complementary reactive groups in the polymer to be crosslinked. Thus, isocyanates react, for example, with alcohols to give urethanes, with amines to give urea derivatives, while epoxides react with these complementary groups to give hydroxyethers and hydroxyamines respectively.

The term post-crosslinking is also taken to mean photochemical curing or oxidative or air- or moisture-induced curing of the systems.

The above-mentioned monomers and crosslinking agents can be combined and (co)polymerised with one another as desired and in a targeted manner in such a way that an optionally crosslinked (co)polymer having the desired refractive index and the requisite stability criteria and mechanical properties is obtained.

It is also possible additionally to copolymerise further common monomers, for example acrylates, methacrylates, vinyl esters, butadiene, ethylene or styrene, in order, for example, to set the glass transition temperature or the mechanical properties of the core and/or shell polymers as needed.

It is likewise preferred in accordance with the invention for the application of the shell of organic polymers to be carried out by grafting, preferably by emulsion polymerisation or ATR polymerisation. The methods and monomers described above can be employed correspondingly here.

The following examples are intended to explain the invention in greater detail without limiting it.

### EXAMPLES

### Example 1

### Production of the Core/Shell Particles

A mixture, held at 4° C., consisting of 1519 g of deionised water, 2.8 g of 1,4-butanediol diacrylate (MERCK), 25.2 g of styrene (MERCK) and 1030 mg of sodium dodecylsulfate (MERCK) is introduced into a 5 l jacketed reactor, held at 75° C. and fitted with double-propeller stirrer, argon protective-gas inlet and reflux condenser and dispersed with vigorous stirring.

Immediately thereafter, the reaction is initiated by successive injection of 350 mg of sodium dithionite (MERCK), 1.75 g of ammonium peroxodisulfate (MERCK) and a further 350 mg of sodium dithionite (MERCK), each dissolved in about 20 ml of water. The injection is carried out by means of disposable syringes.

After 20 min, a monomer emulsion consisting of 56.7 g of 1,4-butanediol diacrylate (MERCK), 510.3 g of styrene (MERCK), 2.625 g of sodium dodecylsulfate (MERCK), 0.7 g of KOH and 770 g of water is metered in continuously over a period of 120 min via the rotary piston pump.

The reactor contents are stirred for 30 min without further addition.

A second monomer emulsion consisting of 10.5 g of allyl methacrylate (MERCK), 94.50 g of methyl methacrylate (MERCK), 0.525 g of sodium dodecylsulfate (MERCK) and 140 g of water is subsequently metered in continuously over a period of 30 min via the rotary piston pump.

After about 15 min, 350 mg of ammonium peroxodisulfate (MERCK) are added, and the mixture is then stirred for a further 15 min.

Finally, a third monomer emulsion consisting of 200 g. of ethyl acrylate (MERCK), 0.550 g of sodium dodecylsulfate (MERCK) and 900 g of water is metered in continuously over a period of 240 min via the rotary piston pump. The mixture is subsequently stirred for a further 120 min.

Before and after each introduction of monomer emulsions and after introduction of the initial mixture, argon is passed into the jacketed reactor as protective-gas cushion for about one minute.

Next day, the reactor is warmed to 95° C., and a steam distillation is carried out in order to remove residual unreacted monomers from the latex dispersion.

This results in a dispersion of core/shell particles in which the shell has a proportion by weight of about 22%. The core of polystyrene is crosslinked, the interlayer is likewise crosslinked (p(MMA-co-ALMA)) and serves for grafting the shell of uncrosslinked ethyl acrylate.

### Example 2

### Production of an Inverse Opal Structure

In order to form the template-forming structure, i.e. the organisation of the core/shell particles in spherical close packing, 5 g of the latex dispersion are poured into a shallow glass dish having a diameter of 7 cm and dried, in air, giving flakes which shimmer in colours.

One such flake is evacuated in a round-bottomed flask using a rotary slide-valve oil pump. A precursor solution consisting of 5 ml of tetra-n-butyl orthotitanate in 5 ml of absolute ethanol is subsequently added in a static vacuum so that the dissolved precursor, driven by capillary forces, is able to penetrate into the cavities of the template. An argon cushion is added above the solution containing the impregnated template. This arrangement is left to stand for a few hours before the impregnated flake is removed in a stream of argon protective gas and calcined at 500° C. in a corundum boat in a tubular furnace.

As a result, inverse structures are obtained which consist of closest-packed cavities in TiO₂ (FIG. 1).

### FIGURES

FIG. 1: Scanning electron photomicrograph of the inverse opal structure of titanium dioxide (Example 2). The regular arrangement of the identical cavities is evident over a large region. The cavities are connected to one another by channels, giving the possibility of filling via the liquid or gas phase

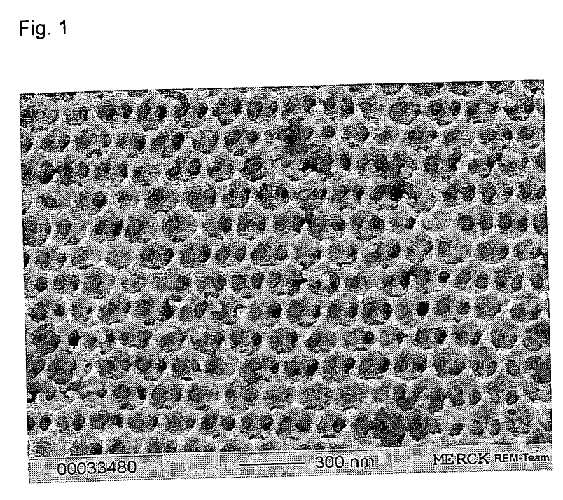

1. Use of core/shell particles whose shell forms a matrix and whose core is essentially solid and has an essentially monodisperse size distribution as template for the production of inverse opal structures.

2. Use according to claim 1, characterised in that the shell in the core/shell particles is bonded to the core via an interlayer.

3. Use according to claim 1, characterised in that the core shell weight ratio in the core/shell particles is in the range from 20:1 to 1.4:1, preferably in the range from 6:1 to 2:1 and particularly preferably in the range from 5:1 to 3.5:1.

4. Use according to claim 1, characterised in that the shell in the core/shell particles consists of essentially uncrosslinked organic polymers, which are preferably grafted onto the core via an at least partially crosslinked interlayer.

5. Use according to claim 1, characterised in that the core in the core/shell particles consists of an organic polymer, which is preferably crosslinked.

6. Use according to claim 1, characterised in that the core in the core/shell particles consists of an inorganic material, and the core/shell weight ratio is preferably in the range from 5:1 to 1:10, in particular in the range from 2:1 to 1:5 and particularly preferably in the region below 1:1.

7. Process for the production of inverse opal structures, characterised in that
a) a dispersion of core/shell particles whose shell forms a matrix and whose core is essentially solid is dried,
b) optionally one or more precursors of suitable wall materials are added, and
c) the cores are subsequently removed.

8. Process for the production of inverse opal structures according to claim 7, characterised in that, in a step a2), the application of a mechanical force to a mass of the core/shell particles pre-dried in step a1) takes place.

9. Process for the production of inverse opal structures according to claim 8, characterised in that the action of a mechanical force takes place through uniaxial pressing or during an injection-moulding operation or during a transfer moulding operation or during (co)extrusion or during a calendering operation or during a blowing operation.

10. Process for the production of inverse opal structures according to claim 7, characterised in that the precursor in step b) is a solution of an ester of an inorganic ortho-acid with a lower alcohol.

11. Process for the production of inverse opal structures according to claim 7, characterised in that step b) is carried out under reduced pressure, preferably in a static vacuum of p<1 mbar.

12. Process for the production of inverse opal structures according to claim 1, characterised in that step c) comprises calcination, preferably at temperatures above 200° C., particularly preferably above 400° C.

13. Process for the production of inverse opal structures according to claim 7, characterised in that step c) is an etching process, preferably etching with HF.

14. Process for the production of inverse opal structures according to claim 1, characterised in that the core/shell particles are removed in step c).
